(19) United States
(12) Patent Application Publication
(10) Pub. No.: US 2011/0248575 A1
(43) Pub. Date: Oct. 13, 2011

(54) TELEVISION SYSTEM WITH WIRELESS POWER TRANSMISSION FUNCTION, TELEVISION SET, AND SET-TOP BOX

(75) Inventors: Nam Yun KIM, Seoul (KR); Young Tack HONG, Seongnam-si (KR); Sang Wook KWON, Seongnam-si (KR); Eun Seok PARK, Suwon-si (KR); Young Ho RYU, Yongin-si (KR)

(73) Assignee: SAMSUNG ELECTRONICS CO., LTD.

(21) Appl. No.: 13/082,331

(22) Filed: Apr. 7, 2011

(30) Foreign Application Priority Data
Apr. 8, 2010 (KR) 10-2010-0032136

(51) Int. Cl. H01F 38/14

(52) U.S. Cl. 307/104

(57) ABSTRACT

A television (TV) system with a wireless power transmission function is provided. The TV system includes a TV set, a set-top box (STB) and a shielding unit. The STB includes a source resonating unit and the TV set includes a target resonating unit to receive a resonance power from the source resonating unit. The shielding unit may be configured to focus a magnetic field to the target resonating unit, where the magnetic is field radiated by the source resonating unit.

### CROSS-REFERENCE TO RELATED APPLICATION(S)

This application claims the benefit under 35 U.S.C. §119(a) of Korean Patent Application No. 10-2010-0032136, filed on Apr. 8, 2010, in the Korean Intellectual Property Office, the entire disclosure of which is incorporated herein by reference for all purposes.

### BACKGROUND

1. Field

The following description relates to a television (TV) system, and more particularly, a TV system having a wireless power transmission function.

2. Description of Related Art

Generally, a TV system may receive a power supply or an image signal via various wired cables such as power cables, and the like.

Currently, the application of wireless power supply technologies is being explored in environments where wired power supply technologies have traditionally been applied. That is, research is being conducted on wireless power transmission technologies that may wirelessly supply power to an electronic device. A wireless power transmission technology may enable energy to be wirelessly transmitted from a power source to the electronic device.

Accordingly, there is a desire for a TV system having a wireless power transmission function.

### SUMMARY

In one general aspect, there is provided a television (TV) system including a TV set-top box (STB), a TV set and a shielding unit. The TV STB includes a source resonating unit, the source resonating unit configured to transmit a resonance power to the TV set. The TV set includes a target resonating unit, the target resonating unit configured to receive the resonance power from the source resonating unit. The shielding unit is configured to focus a magnetic field to the target resonating unit, the magnetic field radiated by the source resonating unit in an omni-direction.

The source resonating unit may be disposed on an upper end of the TV STB, and the source resonating unit may include a source resonator and a shielding film configured to prevent a current offset between the source resonator and a substrate.

The source resonator may include a transmission line unit comprising a plurality of transmission line sheets arranged in parallel and a capacitor inserted in a predetermined location of the transmission line unit.

The target resonating unit may be disposed in a lower end of a supporter of the TV set, or in a rear surface of the TV set, and may include a target resonator operated at a same resonance frequency as the source resonating unit.

The target resonator may include a transmission line unit including a plurality of transmission line sheets arranged in parallel and a capacitor inserted in a predetermined location of the transmission line unit.

The shielding unit may include a housing made of metals and a near field focusing unit configured to have a High Impedance Surface (HIS) characteristic, the near field focusing unit disposed in the housing.

The near field focusing unit may be configured so that a magnetic field of the source resonating unit has an in-phase characteristic.

The television system may further include a plurality of charge target devices. The source resonating unit may detect the plurality of charge target devices. Each of the plurality of charge target devices may receive the resonance power from the source resonating unit by magnetic coupling.

Each of the plurality of charge target devices may receive the resonance power from the source resonating unit, regardless of whether the TV set is powered on or off.

The source resonating unit may detect the TV set, and the plurality of charge target devices may use an identifier of the TV set and identifiers of the plurality of target devices. The source resonating unit may generate a resonance power based on a total sum of a power demanded by the TV set and a power demanded by each of the plurality of charge target devices.

The source resonating unit may receive a control signal for the TV set from a remote controller, and control a function of the TV set based on the control signal.

In another aspect, there is provided a television (TV) set including a target resonating unit which includes a target resonator. The target resonating unit is configured to receive resonance power from a source resonance unit and the target resonator is operated at a same resonance frequency as the source resonating unit.

The target resonator may include a transmission line unit including a plurality of transmission line sheets arranged in parallel and a capacitor inserted in a predetermined location of the transmission line unit.

In another general aspect, there is provided a television (TV) set-top box (STB) including a source resonating unit configured to transmit a resonance power to a TV set, the source resonating unit including a source resonator and a shielding film configured to prevent a current offset between the source resonator and a substrate.

The source resonating unit may be disposed on an upper end of the TV STB.

The source resonator may include a transmission line unit which includes a plurality of transmission line sheets arranged in parallel and a capacitor inserted in a predetermined location of the transmission line unit.

The source resonating unit may detect a plurality of charge target devices and the plurality of charge target devices may be configured to receive the resonance power from the source resonating unit by magnetic coupling.

The source resonating unit may detect the TV set and the plurality of charge target devices using an identifier of the TV set and identifiers of the plurality of target devices. The source resonating unit may generate a resonance power based on a total sum of a power demanded by the TV set and a power demanded by each of the plurality of charge target devices.

The source resonating unit may receive a control signal for the TV set from a remote controller and control a function of the TV set based on the control signal.

Other features and aspects will be apparent from the following detailed description, the drawings, and the claims.

### BRIEF DESCRIPTION OF THE DRAWINGS

FIG. 1 is a diagram illustrating an example of a principle of a television (TV) system is having a wireless power transmission function.

FIG. 2 is a diagram illustrating an example of a TV system having a wireless power transmission function.

FIG. 3 is a diagram illustrating another example of a TV system having a wireless power transmission function.

FIG. 4 is a block diagram illustrating an example of a structure of a TV source resonating unit.

FIG. 5 is a block diagram illustrating an example of a structure of a TV set.

FIG. 6 is a diagram illustrating a front and side view of an example of a TV set.

FIG. 7 is a diagram illustrating an example of a target resonating unit of the TV set of FIG. 6.

FIGS. 8 and 9 are diagrams illustrating examples of a TV set-top box (STB).

FIG. 10 is a diagram illustrating an example of a shielding film.

FIG. 11 is a diagram illustrating an example of a structure of a resonator.

FIG. 12 is a diagram illustrating an insertion location of a capacitor of FIG. 11.

FIG. 13 is a diagram illustrating an example of a structure of a shielding unit.

FIG. 14 is a diagram illustrating another example of a TV system having a wireless power transmission function.

FIGS. 15 through 21B are diagrams illustrating various examples of a resonator.

FIG. 22 is a diagram illustrating an example of an equivalent circuit of the resonator of FIG. 15.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, description of well-known functions and constructions may be omitted for increased clarity and conciseness.

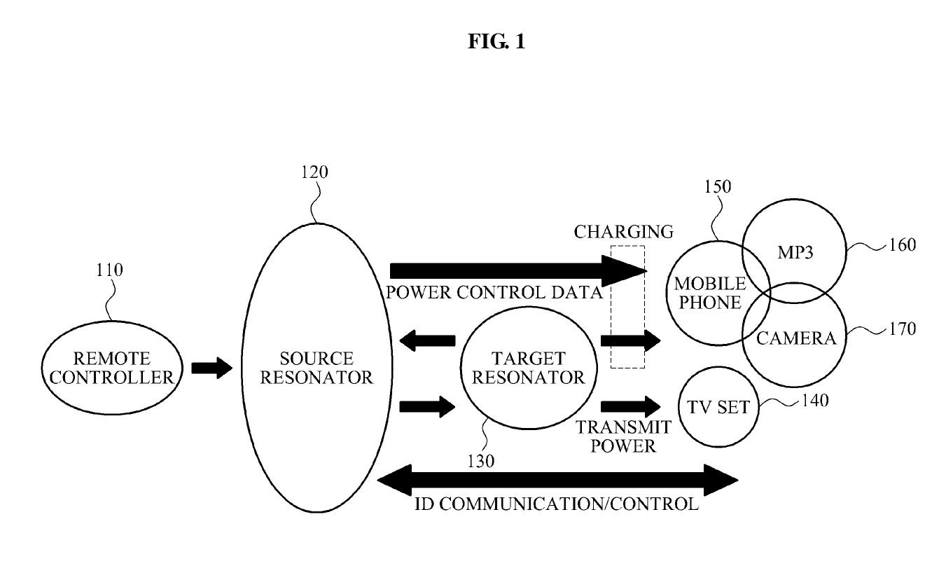

FIG. 1 illustrates an example of a principle of a television (TV) system having a wireless power transmission function.

Referring to the example in FIG. 1, a source resonator 120 and a target resonator 130 exist in an area where an energy is coupled. At least one target resonator 130 may exist in the area. Specifically, the target resonator 130 may be included in an electronic device such as a TV set 140. The target resonator 130 may also be included in each of a plurality of charge target devices, for example a mobile phone 150, a Moving Pictures Experts Group Layer 3 (MP3) player 160, a camera 170, and the like. These target devices are listed for the purpose of example only. The target device may include other electronic devices not listed above.

A resonance power transmitted from the source resonator 120 to the target resonator 130 is generated by an alternating current (AC) resonance power generation circuit. Hereinafter, a device including the AC resonance power generation circuit and the source resonator 120 are also referred to as a source resonating unit.

The source resonating unit detects a target device or devices, such as the mobile phone 150, the MP3 player 160, and the camera 170, and each of the plurality of charge target devices may receive the resonance power from the source resonating unit by magnetic coupling. Specifically, magnetic coupling of 1:N may occur between the source resonating unit, and each of the mobile phone 150, the MP3 player 160, and the camera 170 in this example.

Additionally, each of the mobile phone 150, the MP3 player 160, and the camera 170 may receive the resonance power from the source resonating unit, even when the TV set 140 is powered off.

The source resonating unit receives an identifier of each of the TV set 140, the mobile phone 150, the MP3 player 160, and the camera 170 and detects the number of charge target devices or a total demand power, based on the received identifiers. That is, the source resonating unit detects each of the TV set 140, the mobile phone 150, the MP3 player 160, and the camera 170, using the identifiers. Accordingly, the source resonating unit may generate a resonance power based on a total sum of a power demanded by each of the TV set 140, the mobile phone 150, the MP3 player 160, and the camera 170.

Additionally, the source resonating unit may receive a control signal for the TV set 140 from a remote controller 110, and control a function of the TV set 140 based on the control signal.

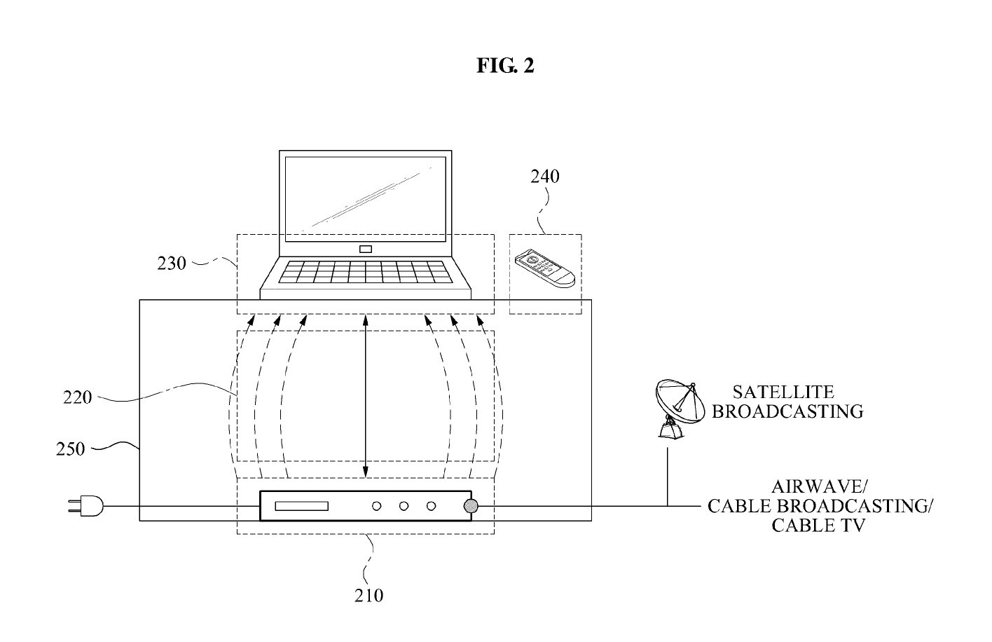

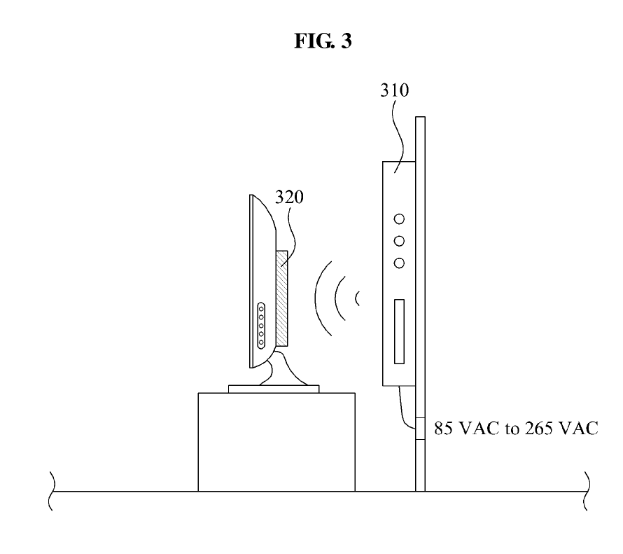

FIG. 2 illustrates an example of a TV system having a wireless power transmission function.

Referring to the example in FIG. 2, the TV system may include a TV set-top box (STB) 210, a TV set 230, and a cabinet 250.

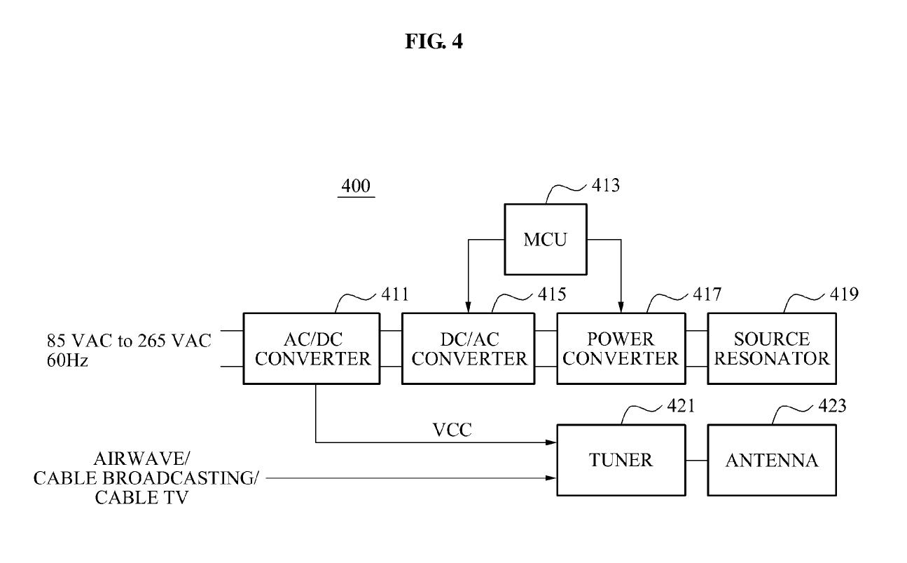

The TV STB 210 may include a source resonating unit (not shown) to transmit the resonance power to the TV set 230. When an AC power of 85 VAC to 265 VAC at 60 hertz (Hz) is applied to the source resonating unit, the source resonating unit generates a resonance power. The source resonating unit in the TV STB 210 is further described below with reference to FIG. 4.

The TV set 230 may include a target resonating unit (not shown) to receive the resonance power. The TV set 230 is located a distance 220 that enables an energy coupling with the source resonating unit in the TV STB 210.

The cabinet 250 may include a shielding unit (not shown) to shield an electromagnetic wave so as not to affect an external device during transmission of resonance power. Specifically, the shielding unit may focus a magnetic field to the target resonating unit, so as not to affect the external device. Here, the magnetic field may be radiated by the source resonating unit in an omni-direction. When a device 240 having a same resonance frequency as the source resonating unit is located on the cabinet 250, the device 240 may be charged wirelessly with power.

A user may turn on the TV system by manipulating a remote controller or a power button of the TV STB 210. Accordingly, when a “power on signal” to power on the TV system is received, the TV STB 210 initiates transmission of resonance power.

FIG. 3 illustrates another example of a TV system having a wireless power transmission function.

Referring to the example in FIG. 3, a TV STB 310 may be fixed on a wall, and a target resonating unit 320 included on a rear surface of a TV set. However, FIG. 3 simply represents one example of how the TV STB 310 may be positioned relative to the target resonating unit 320. Other suitable arrangements may be employed as well.

FIG. 4 illustrates an example of a structure of a TV source resonating unit.

Referring to the example in FIG. 4, a TV source resonating unit 400 includes an AC-to-DC (AC/DC) converter 411, a main control unit (MCU) 413, a DC-to-AC (DC/AC) converter 415, a power converter 417, a source resonator 419, a tuner 421, and an antenna 423.

The AC/DC converter 411 receives an AC voltage of 85 VAC to 265 VAC at 60 Hz, and converts the received AC voltage into a DC voltage. The converted DC voltage is then supplied to the tuner 421.

The MCU 413 controls the DC/AC converter 415 and the power converter 417 so that a target resonator may generate a voltage and power that are to be required.

The DC/AC converter 415 generates an AC signal in a band of 4 megahertz (MHz) to 20 MHz, from a DC power.

The power converter 417 generates power using the AC signal output from the DC/AC converter 415.

The source resonator 419 transmits the generated power to a target resonator (not shown).

The tuner 421 restores a desired signal among various broadcast signals.

The antenna 423 may receive an image signal, or may transmit an image signal to a TV set.

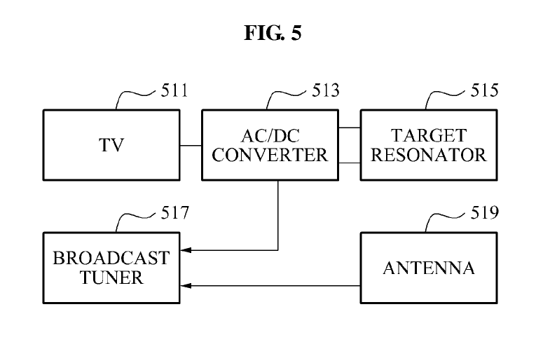

FIG. 5 illustrates an example of a structure of a TV set.

Referring to the example in FIG. 5, the TV set includes a TV 511, an AC/DC converter 513, a target resonator 515, a broadcast tuner 517, and an antenna 519.

The TV 511 may be used as a broadcast signal receiving apparatus including a display.

The target resonator 515 may be operated at a same resonance point as a source resonator, and receive a resonance power.

The AC/DC converter 513 converts a received AC signal into a DC signal. The converted DC signal is then supplied as power used for each portion of the TV set. The AC/DC converter 513 may include a rectifier. For example, the rectifier may include at least one diode, a resistance, a condenser, and a coil. The rectifier may also include a smoothing circuit, and convert a high frequency signal to a DC signal using the smoothing circuit.

The broadcast tuner 517 restores an image signal of a channel desired by a user from among received signals.

The antenna 519 may receive an image signal, or may transmit a signal to a TV STB.

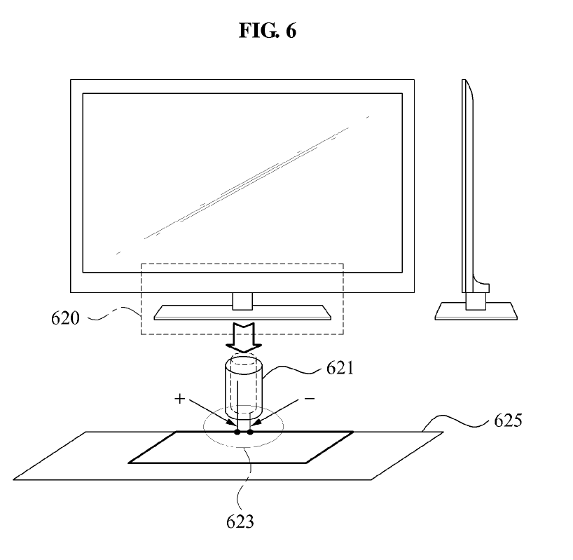

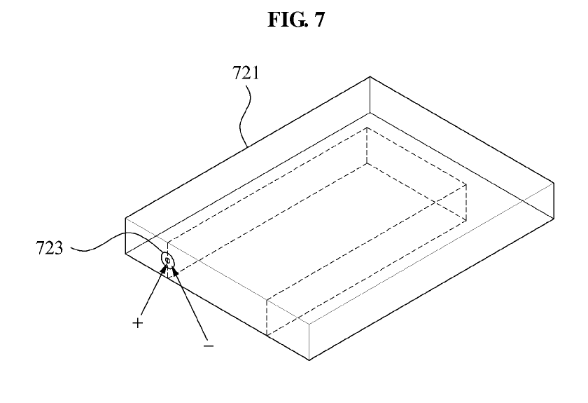

FIG. 6 illustrates an example of a TV set. FIG. 7 illustrates an example of a target resonating unit 625 of FIG. 6, which is further described below.

Referring to the example in FIG. 6, a TV set 620 includes a support 621, and a power connector 623 to connect the support 621 to the target resonating unit 625.

The target resonating unit 625 includes a target resonator 721 and an output port 723, in one example, as shown in FIG. 7. The output port 723 may provide, to the AC/DC converter 513, a current output from the target resonator 721.

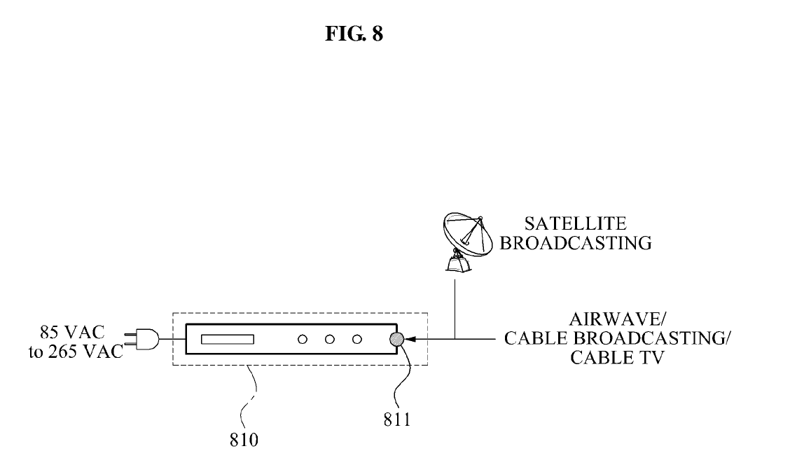

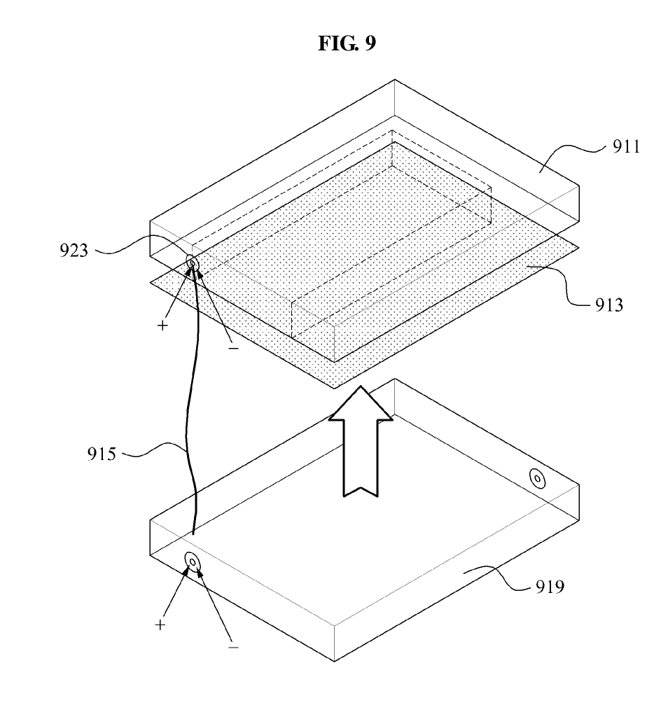

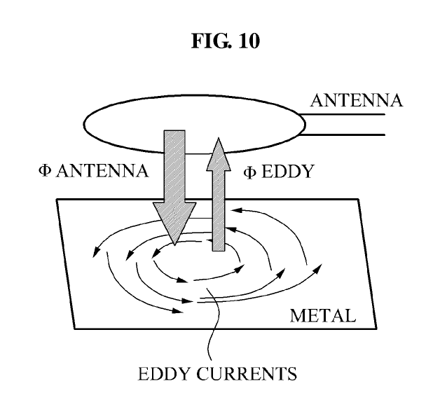

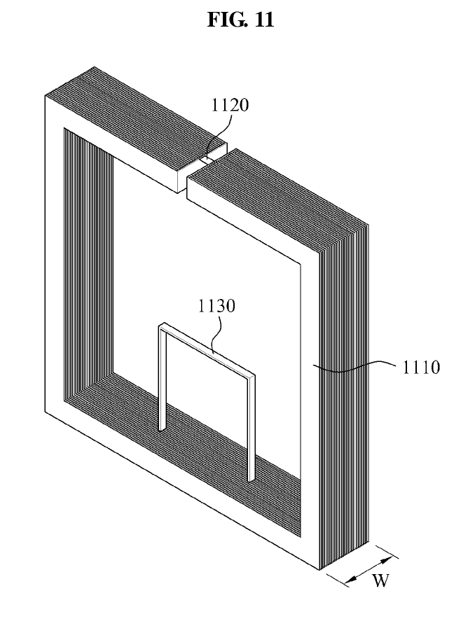

FIGS. 8 and 9 illustrate examples of a TV STB.

Referring to the example in FIG. 8, a TV STB 810 includes a connector 811 to receive a broadcast signal via a cable.

Referring to the example in FIG. 9, a source resonating unit 911 is located on an upper end of a TV STB 919. In this example a shielding film 913 is disposed between the source resonating unit 911 and the TV STB 919. The shielding film 913 may be made of materials with an electromagnetic interference (EMI)/electromagnetic compatibility (EMC) shielding function. Accordingly, the shielding film 913 may reduce or prevent a current offset between the source resonating unit 911 and the TV STB 919. The shielding film 913 may be made of metal materials, and the metal materials may reduce prevent the current offset.

A power cable 915 transfers power from the TV STB 919 to the source resonating unit 911.

The connector 923 may be similar to the connector 811 of FIG. 8.

FIG. 11 illustrates an example of a structure of a resonator.

The structure of the resonator of FIG. 11 may be applied to a source resonator and a target resonator.

Referring to FIG. 11, the resonator includes a transmission line unit 1110, and a capacitor 1120. According to some examples, the resonator may further include a feeding unit 1130.

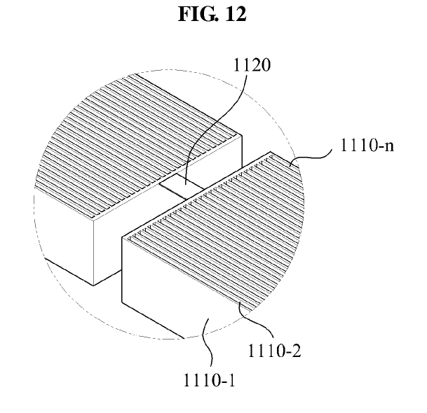

The transmission line unit 1110 includes a plurality of transmission line sheets arranged in parallel. The parallel arrangement of the plurality of transmission line sheets is further described with reference to FIG. 12 below.

The capacitor 1120, in this example, is inserted in a specific location of the transmission line unit 1110. For example, the capacitor 1120 may be inserted in series into an intermediate portion of the transmission line unit 1110. An electric field generated by the resonator may be confined within the capacitor 1120.

The capacitor 1120 may be inserted into the transmission line unit 1110 in a shape of a lumped element and a distributed element, for example, an interdigital capacitor, or a gap capacitor including a substrate that has a high permittivity and that is included in the middle thereof. When the capacitor 1120 is inserted into the transmission line unit 1110, the resonator may have the characteristic of the metamaterial.

The metamaterial refers to a material having a predetermined electrical property that cannot be discovered in nature and thus, may have an artificially designed structure. An electromagnetic characteristic of all the materials existing in nature may have a unique magnetic permeability or a unique permittivity. Most materials may have a positive magnetic permeability or a positive permittivity. In the case of most materials, a right hand rule may be applied to an electric field, a magnetic field, and a pointing vector and thus, the corresponding materials may be referred to as right handed materials (RHMs). However, the metamaterial has a magnetic permeability or a permittivity less than ‘1’ and thus, may be classified into an epsilon negative (ENG) material, a mu negative (MNG) material, a double negative (DNG) material, a negative refractive index (NRI) material, a left-handed (LH) material, and the like, based on a sign of the corresponding permittivity or magnetic permeability.

When a capacitance of the capacitor 1120 inserted as the lumped element is appropriately determined, the resonator may have the characteristic of the metamaterial. Since the resonator may have a negative magnetic permeability by appropriately adjusting the capacitance of the capacitor 1120, the resonator may also be referred to as an MNG resonator.

The resonator, also referred to as the MNG resonator, may have a zeroth order resonance characteristic of having, as a resonance frequency, a frequency when a propagation constant is “0”. Since the resonator may have the zeroth order resonance characteristic, the resonance frequency may be independent with respect to a physical size of the MNG resonator. By appropriately designing the capacitor 1120, the MNG resonator may sufficiently change the resonance frequency. Accordingly, the physical size of the MNG resonator may not be changed.

The feeding unit 1130 performs a function of feeding a current to the MNG resonator. The feeding unit 1130 may be designed so that a current fed to the resonator may be uniformly distributed to the plurality of transmission line sheets.

FIG. 12 illustrates an insertion location of the capacitor 1120 of FIG. 11.

Referring to the example in FIG. 12, the capacitor 1120 is inserted into the intermediate portion of the transmission line unit 1110. The intermediate portion of the transmission line unit 1110 is opened so that the capacitor 1120 may be inserted into the transmission line unit 1110. Transmission line sheets 1110-1, 1110-2, . . . , and 1110-n are connected in parallel in the intermediate portion of the transmission line unit 1110 in this example.

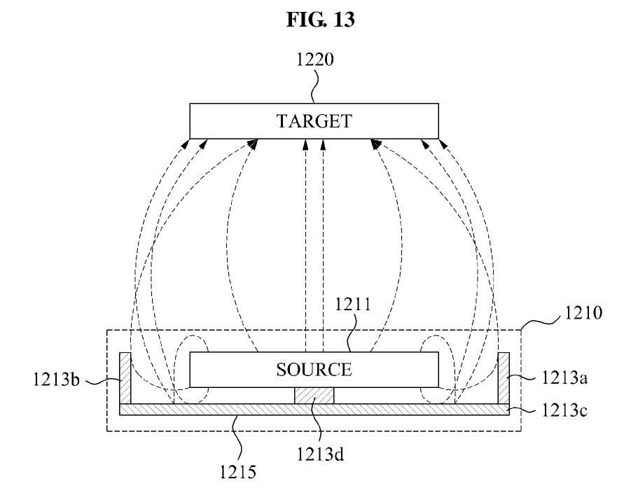

FIG. 13 illustrates an example of a structure of a shielding unit.

Referring to the example in FIG. 13, a shielding unit 1210 is included in a cabinet, and the cabinet may be shielded by a housing (not shown) made of metal materials.

The shielding unit 1210 includes a near field focusing unit 1215. The near field focusing unit 1215 may be included in the housing, and is designed to have a High Impedance Surface (HIS) characteristic.

In this example, the near field focusing unit 1215 includes side focusing units 1213a and 1213b, a rear surface focusing unit 1213c, and a supporter unit 1213d.

The side focusing units 1213a and 1213b control a direction of a side magnetic field of a source unit 1211, so that the side magnetic field of the source unit 1211 may be focused on a target unit 1220, as shown in FIG. 13, for example. Here, the source unit 1211 may include, for example, a source resonator, or a TV STB.

The rear surface focusing unit 1213c controls a direction of a rear surface magnetic field of the source unit 1211, so that the rear surface magnetic field of the source unit 1211 may be focused on the target unit 1220, as shown in the example of FIG. 13.

Since the near field focusing unit 1215 may be designed to have the HIS characteristic as described above, the near field focusing unit 1215 may minimize or reduce a change in a resonance frequency or a Q-factor of a source resonator by minimizing a ground effect.

Here, the HIS characteristic may be designed based on a resonance frequency of the source unit 1211. In other words, the near field focusing unit 1215 may be designed so that a magnetic field of the source unit 1211 has an in-phase characteristic. When the near field focusing unit 1215 has the HIS characteristic, the magnetic field generated by the source unit 1211 may have the in-phase characteristic with respect to the near field focusing unit 1215.

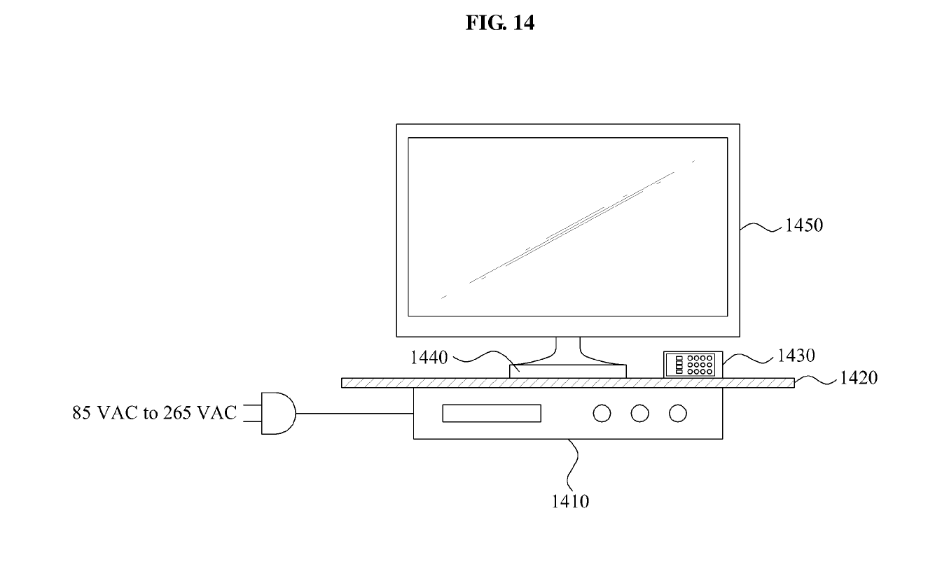

FIG. 14 illustrates another example of a TV system having a wireless power transmission function.

An STB 1410 of FIG. 14 may perform the same function as the TV STB 210 of FIG. 2. Specifically, the STB 1410 includes a source resonating unit (not shown). The source resonating unit in the STB 1410 transmits a resonance power to a target resonating unit 1440 included in a TV set 1450. The target resonating unit 1440 of FIG. 14 may perform the same function as the target resonating unit included in the TV set 230 of FIG. 2.

In the example of FIG. 14, a reference numeral 1420 denotes a pad to provide a similar function to the cabinet 250 of FIG. 2. In other words, a charge target device 1430 and the TV set 1450 are placed on the pad 1420 and thus, a resonance power may be received from the source resonating unit. Additionally, the pad 1420 may be made of materials with the EMI/EMC shielding function.

The example of the TV system of FIG. 2 may be distinguished in structure from the example of the TV system of FIG. 14. For example, the TV system of FIG. 2 has a non-connection type resonance power transceiving structure, and the TV system of FIG. 14 may has a pad connection type resonance power transceiving structure. A user may select either the “non-connection type resonance power transceiving structure” or the “pad connection type resonance power transceiving structure”, based on an environment of space where a TV system is to be installed.

As described above, it is possible to efficiently install various TVs and monitors, for example a light emitting diode (LED) TV, a liquid crystal display (LCD) TV, a plasma display panel (PDP) TV, and the like, by receiving an image and a power supply without connecting a separate cable. Additionally, various devices and mobile devices that have the same resonance frequency as a source resonating unit may be wirelessly charged with power. In other words, it is possible to perform multi-charging of at least one device.

A source resonator and/or a target resonator may be configured as a helix coil structured resonator, a spiral coil structured resonator, a meta-structured resonator, and the like.

Hereinafter, related terms, are described for further understanding. All the materials may have a unique magnetic permeability, i.e., Mu and a unique permittivity, i.e., epsilon. The magnetic permeability indicates a ratio between a magnetic flux density occurring with respect to a given magnetic field in a corresponding material and a magnetic flux density occurring with respect to the given magnetic field in a vacuum state. The magnetic permeability and the permittivity may determine a propagation constant of a corresponding material in a given frequency or a given wavelength. An electromagnetic characteristic of the corresponding material may be determined based on the magnetic permeability and the permittivity. In particular, a material having a magnetic permeability or a permittivity absent in nature and being artificially designed is referred to as a metamaterial. The metamaterial may be easily disposed in a resonance state even in a relatively large wavelength area or a relatively low frequency area. For example, even though a material size rarely varies, the metamaterial may be easily disposed in the resonance state.

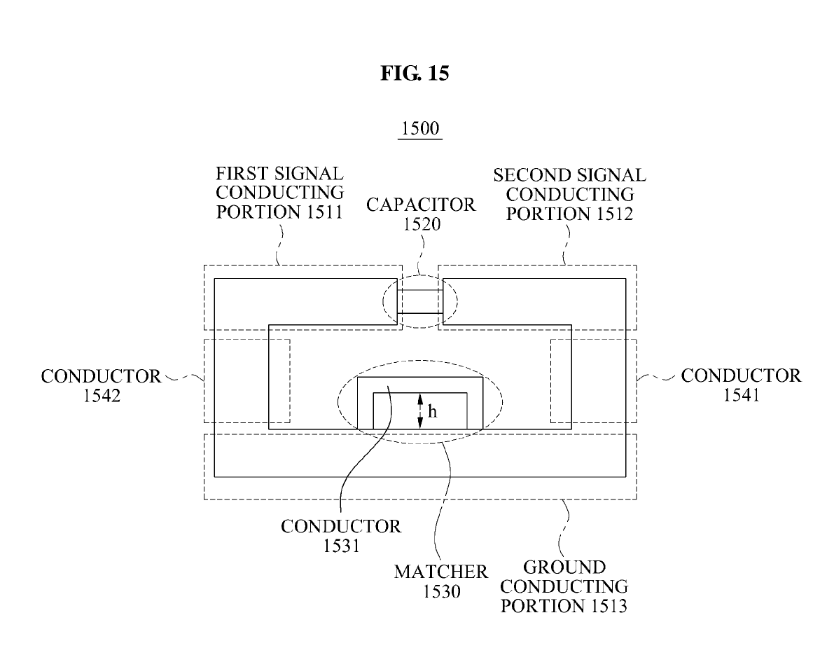

FIG. 15 illustrates an example of a resonator 1500 having a two-dimensional (2D) structure.

Referring to FIG. 15, the resonator 1500 having the 2D structure includes a transmission line, a capacitor 1520, a matcher 1530, and conductors 1541 and 1542. The transmission line includes a first signal conducting portion 1511, a second signal conducting portion 1512, and a ground conducting portion 1513.

The capacitor 1520 may be inserted in series between the first signal conducting portion 1511 and the second signal conducting portion 1512, whereby an electric field may be confined within the capacitor 1520. Generally, the transmission line may include at least one conductor in an upper portion of the transmission line, and may also include at least one conductor in a lower portion of the transmission line. A current may flow through the at least one conductor disposed in the upper portion of the transmission line and the at least one conductor disposed in the lower portion of the transmission may be electrically grounded. Herein, a conductor disposed in an upper portion of the transmission line may be separated into and thereby be referred to as the first signal conducting portion 1511 and the second signal conducting portion 1512. A conductor disposed in the lower portion of the transmission line may also be referred to as the ground conducting portion 1513.

As shown in the example of FIG. 15, the resonator 1500 may have the 2D structure. The transmission line includes the first signal conducting portion 1511 and the second signal conducting portion 1512 in the upper portion of the transmission line, and the ground conducting portion 1513 in the lower portion of the transmission line. The first signal conducting portion 1511 and the second signal conducting portion 1512 may be disposed to face the ground conducting portion 1513. The current may flow through the first signal conducting portion 1511 and the second signal conducting portion 1512.

One end of the first signal conducting portion 1511 is shorted to the conductor 1542, and another end of the first signal conducting portion 1511 is connected to the capacitor 1520. One end of the second signal conducting portion 1512 is grounded to the conductor 1541, and another end of the second signal conducting portion 1512 is connected to the capacitor 1520. Accordingly, in this example, the first signal conducting portion 1511, the second signal conducting portion 1512, the ground conducting portion 1513, and the conductors 1541 and 1542 are connected to each other, whereby the resonator 1500 may have an electrically closed-loop structure. The term “loop structure” may include a polygonal structure, for example, a circular structure, a rectangular structure, and the like. “Having a loop structure,” in the context of this example, refers to being electrically closed.

The capacitor 1520 may be inserted into an intermediate portion of the transmission line. Specifically, in one example, the capacitor 1520 is inserted into a space between the first signal conducting portion 1511 and the second signal conducting portion 1512. The capacitor 1520 may have a shape of a lumped element, a distributed element, and the like. In particular, a distributed capacitor having the shape of the distributed element may include zigzagged conductor lines and a dielectric material having a relatively high permittivity between the zigzagged conductor lines.

When the capacitor 1520 is inserted into the transmission line, the resonator 1500 may have a property of a metamaterial. The metamaterial indicates a material having a predetermined electrical property that cannot be discovered in nature and thus, may have an artificially designed structure. An electromagnetic characteristic of all the materials existing in nature may have a unique magnetic permeability or a unique permittivity. Most materials may have a positive magnetic permeability or a positive permittivity. In the case of most materials, a right hand rule may be applied to an electric field, a magnetic field, and a pointing vector and thus, the corresponding materials may be referred to as RHMs. However, the metamaterial has a magnetic permeability or a permittivity absent in nature and thus, may be classified into an ENG material, an MNG material, a DNG material, an NRI material, an LH material, and the like, based on a sign of the corresponding permittivity or magnetic permeability.

When a capacitance of the capacitor inserted as the lumped element is appropriately determined, the resonator 1500 may have the characteristic of the metamaterial. Since the resonator 1500 may have a negative magnetic permeability by appropriately adjusting the capacitance of the capacitor 1520, the resonator 1500 may also be referred to as an MNG resonator. Various criteria may be applied to determine the capacitance of the capacitor 1520. For example, the various criteria may include a criterion for enabling the resonator 1500 to have the characteristic of the metamaterial, a criterion for enabling the resonator 1500 to have a negative magnetic permeability in a target frequency, a criterion for enabling the resonator 1500 to have a zeroth order resonance characteristic in the target frequency, and the like. Based on at least one criterion among the aforementioned criteria, the capacitance of the capacitor 1520 may be determined.

The resonator 1500, also referred to as the MNG resonator 1500, may have a zeroth order resonance characteristic of having, as a resonance frequency, a frequency when a propagation constant is “0”. Since the resonator 1500 may have the zeroth order resonance characteristic, the resonance frequency may be independent with respect to a physical size of the MNG resonator 1500. By appropriately designing the capacitor 1520, the MNG resonator 1500 may sufficiently change the resonance frequency. Accordingly, the physical size of the MNG resonator 1500 may not be changed.

In a near field, the electric field may be concentrated on the capacitor 1520 inserted into the transmission line. Accordingly, due to the capacitor 1520, the magnetic field may become dominant in the near field. The MNG resonator 1500 may have a relatively high Q-factor, using the capacitor 1520 of the lumped element and thus, it is possible to enhance an efficiency of power transmission. Here, the Q-factor indicates a level of an ohmic loss or a ratio of a reactance with respect to a resistance in the wireless power transmission. It may be understood that the efficiency of the wireless power transmission may increase according to an increase in the Q-factor.

In the example of FIG. 15, the MNG resonator 1500 includes the matcher 1530 for impedance matching. The matcher 1530 may appropriately adjust a strength of a magnetic field of the MNG resonator 1500. An impedance of the MNG resonator 1500 may be determined by the matcher 1530. A current may flow in the MNG resonator 1500 via a connector, or may flow out from the MNG resonator 1500 via the connector. The connector may be connected to the ground conducting portion 1513 or the matcher 1530. The power may be transferred through coupling without using a physical connection between the connector and the ground conducting portion 1513 or the matcher 1530.

More specifically, as shown in the example of FIG. 15, the matcher 1530 is positioned within the loop formed by the loop structure of the resonator 1500. The matcher 1530 adjusts the impedance of the resonator 1500 by changing the physical shape of the matcher 1530. For example, the matcher 1530 includes the conductor 1531 for the impedance matching in a location separate from the ground conducting portion 1513 by a distance h. The impedance of the resonator 1500 may be changed by adjusting the distance h.

Although not illustrated in FIG. 15, a controller may be provided to control the matcher 1530. In this case, the matcher 1530 may change the physical shape of the matcher 1530 based on a control signal generated by the controller. For example, the distance h between the conductor 1531 of the matcher 1530 and the ground conducting portion 1513 may increase or decrease based on the control signal. Accordingly, the physical shape of the matcher 1530 may be changed whereby the impedance of the resonator 1500 is adjusted. The controller may generate the control signal based on various factors, which are described later.

As shown in the example of FIG. 15, the matcher 1530 may be configured as a passive element such as the conductor 1531. Depending on embodiments, the matcher 1530 may be configured as an active element such as a diode, a transistor, and the like. When the active element is included in the matcher 1530, the active element may be driven based on the control signal generated by the controller, and the impedance of the resonator 1500 may be adjusted based on the control signal. For example, a diode that is a type of the active element may be included in the matcher 1530. The impedance of the resonator 1500 may be adjusted depending on whether the diode is in an on state or in an off state.

Although not illustrated in FIG. 15, a magnetic core may be further provided to pass through the MNG resonator 1500. The magnetic core may perform a function of increasing a power transmission distance.

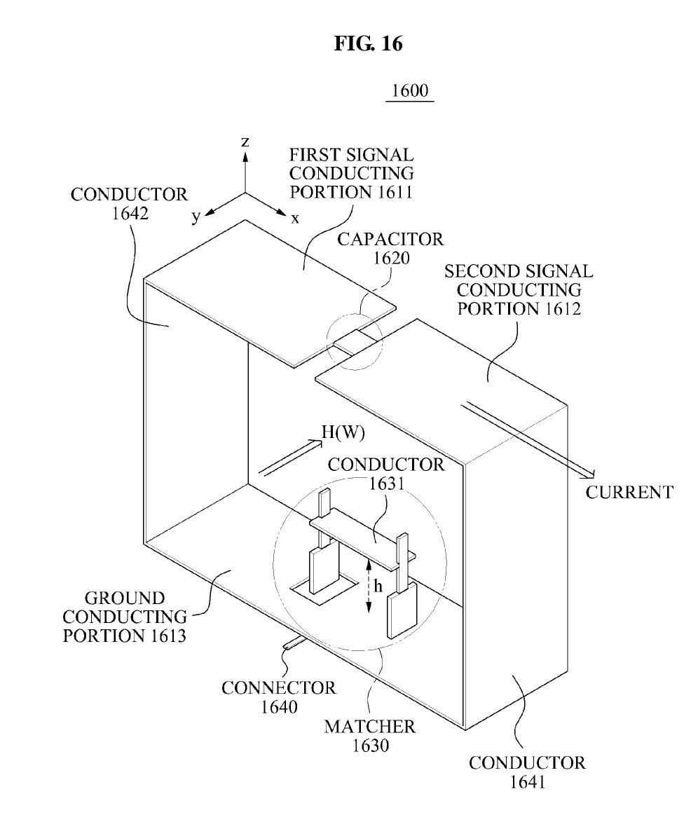

FIG. 16 illustrates an example of a resonator 1600 having a three-dimensional (3D) structure.

Referring to the example in FIG. 16, the resonator 1600 having the 3D structure includes a transmission line and a capacitor 1620. The transmission line includes a first signal conducting portion 1611, a second signal conducting portion 1612, and a ground conducting portion 1613. In this example, the capacitor 1620 is inserted in series between the first signal conducting portion 1611 and the second signal conducting portion 1612 of the transmission link, whereby an electric field may be confined within the capacitor 1620.

As shown in FIG. 16, the resonator 1600 may have the 3D structure. The transmission line includes the first signal conducting portion 1611 and the second signal conducting portion 1612 in an upper portion of the resonator 1600, and the ground conducting portion 1613 in a lower portion of the resonator 1600. In this example, the first signal conducting portion 1611 and the second signal conducting portion 1612 may be disposed to face the ground conducting portion 1613. A current may flow in an x direction through the first signal conducting portion 1611 and the second signal conducting portion 1612. Due to the current, a magnetic field H(W) may be formed in a −y direction. Alternatively, unlike the diagram of FIG. 16, the magnetic field H(W) may be formed in a +y direction.

In this example, one end of the first signal conducting portion 1611 is shorted to the conductor 1642, and another end of the first signal conducting portion 1611 is connected to the capacitor 1620. One end of the second signal conducting portion 1612 is grounded to the conductor 1641, and another end of the second signal conducting portion 1612 is connected to the capacitor 1620. Accordingly, the first signal conducting portion 1611, the second signal conducting portion 1612, the ground conducting portion 1613, and the conductors 1641 and 1642 are connected to each other, whereby the resonator 1600 has an electrically closed-loop structure. The term “loop structure” may include a polygonal structure, for example, a circular structure, a rectangular structure, and the like. “Having a loop structure,” in the context of this example, refers to being electrically closed.

As shown in the example of FIG. 16, the capacitor 1620 is inserted between the first signal conducting portion 1611 and the second signal conducting portion 1612. More specifically, the capacitor 1620 may be inserted into a space between the first signal conducting portion 1611 and the second signal conducting portion 1612. The capacitor 1620 may have a shape of a lumped element, a distributed element, and the like. In particular, a distributed capacitor having the shape of the distributed element may include zigzagged conductor lines and a dielectric material having a relatively high permittivity between the zigzagged conductor lines.

As the capacitor 1620 is inserted into the transmission line, the resonator 1600 may have a property of a metamaterial.

When a capacitance of the capacitor inserted as the lumped element is appropriately determined, the resonator 1600 may have the characteristic of the metamaterial. Since the resonator 1600 may have a negative magnetic permeability by appropriately adjusting the capacitance of the capacitor 1620, the resonator 1600 may also be referred to as an MNG resonator. Various criteria may be applied to determine the capacitance of the capacitor 1620. For example, the various criteria may include a criterion for enabling the resonator 1600 to have the characteristic of the metamaterial, a criterion for enabling the resonator 1600 to have a negative magnetic permeability in a target frequency, a criterion enabling the resonator 1600 to have a zeroth order resonance characteristic in the target frequency, and the like. Based on at least one criterion among the aforementioned criteria, the capacitance of the capacitor 1620 may be determined.

The resonator 1600, also referred to as the MNG resonator 1600, may have a zeroth order resonance characteristic of having, as a resonance frequency, a frequency when a propagation constant is “0”. Since the resonator 1600 may have the zeroth order resonance characteristic, the resonance frequency may be independent with respect to a physical size of the MNG resonator 1600. By appropriately designing the capacitor 1620, the MNG resonator 1600 may sufficiently change the resonance frequency. Accordingly, the physical size of the MNG resonator 1600 may not be changed.

Referring to the MNG resonator 1600 of FIG. 16, in a near field, the electric field may be concentrated on the capacitor 1620 inserted into the transmission line. Accordingly, due to the capacitor 1620, the magnetic field may become dominant in the near field. In particular, since the MNG resonator 1600 having the zeroth-order resonance characteristic may have characteristics similar to a magnetic dipole, the magnetic field may become dominant in the near field. A relatively small amount of the electric field formed due to the insertion of the capacitor 1620 may be concentrated on the capacitor 1620 and thus, the magnetic field may become further dominant.

Also, the MNG resonator 1600 includes the matcher 1630 for impedance matching. The matcher 1630 may appropriately adjust the strength of magnetic field of the MNG resonator 1600. An impedance of the MNG resonator 1600 may be determined by the matcher 1630. A current may flow in the MNG resonator 1600 via a connector 1640, or may flow out from the MNG resonator 1600 via the connector 1640. The connector 1640 is connected to the ground conducting portion 1613 or the matcher 1630.

More specifically, as shown in the example of FIG. 16, the matcher 1630 is positioned within the loop formed by the loop structure of the resonator 1600. The matcher 1630 adjusts the impedance of the resonator 1600 by changing the physical shape of the matcher 1630. For example, the matcher 1630 includes the conductor 1631 for the impedance matching in a location separate from the ground conducting portion 1613 by a distance h. The impedance of the resonator 1600 is changed by adjusting the distance h.

Although not illustrated in FIG. 16, a controller may be provided to control the matcher 1630. In this case, the matcher 1630 may change the physical shape of the matcher 1630 based on a control signal generated by the controller. For example, the distance h between the conductor 1631 of the matcher 1630 and the ground conducting portion 1613 may increase or decrease based on the control signal. Accordingly, the physical shape of the matcher 1630 may be changed whereby the impedance of the resonator 1600 is adjusted. The distance h between the conductor 1631 of the matcher 1630 and the ground conducting portion 1613 may be adjusted using a variety of schemes. As one example, a plurality of conductors may be included in the matcher 1630 and the distance h may be adjusted by adaptively activating one of the conductors. As another example, the distance h may be adjusted by adjusting the physical location of the conductor 1631 up and down. The distance h may be controlled based on the control signal of the controller. These schemes are listed for the purposes of example only, and are not limiting. Other suitable schemes may be employed as well. The controller may generate the control signal using various factors. An example of the controller generating the control signal will be described later.

As shown in the example of FIG. 16, the matcher 1630 is configured as a passive element such as the conductor 1631. In some examples, the matcher 1630 may be configured as an active element such as a diode, a transistor, and the like. When the active element is included in the matcher 1630, the active element may be driven based on the control signal generated by the controller, and the impedance of the resonator 1600 may be adjusted based on the control signal. For example, a diode that is a type of the active element may be included in the matcher 1630. The impedance of the resonator 1600 may be adjusted depending on whether the diode is in an on state or in an off state.

Although not illustrated in FIG. 16, a magnetic core may be further provided to pass through the resonator 1600 configured as the MNG resonator. The magnetic core may perform a function of increasing a power transmission distance.

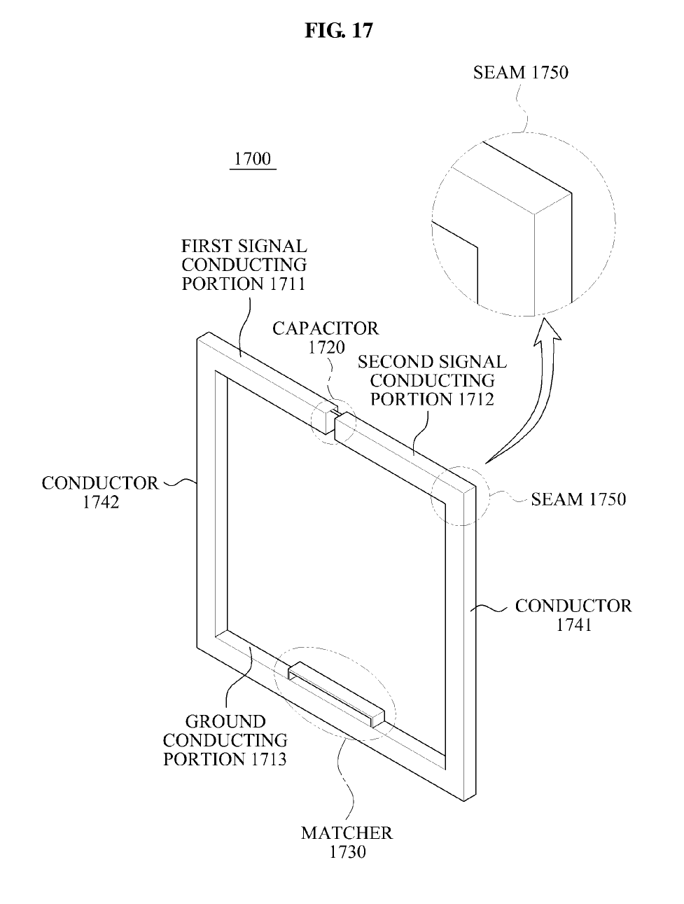

FIG. 17 illustrates an example of a resonator 1700 for a wireless power transmission configured as a bulky type.

Referring to the example in FIG. 17, a first signal conducting portion 1711 and a conductor 1742 may be integrally formed instead of being separately manufactured and thereby be connected to each other. Similarly, a second signal conducting portion 1712 and a conductor 1741 may also be integrally manufactured.

When the second signal conducting portion 1712 and the conductor 1741 are separately manufactured and then are connected to each other, a loss of conduction may occur due to a seam 1750. The second signal conducting portion 1712 and the conductor 1741 may be connected to each other without using a separate seam, that is, the second signal conducting portion 1712 and the conductor 1741 may be seamlessly connected to each other. Accordingly, it is possible to decrease a conductor loss caused by the seam 1750. Accordingly, the second signal conducting portion 1712 and the ground conducting portion 1713 may be seamlessly and integrally manufactured. Similarly, the first signal conducting portion 1711 and the ground conducting portion 1713 may be seamlessly and integrally manufactured.

Referring to the example in FIG. 17, a type of a seamless connection connecting at least two partitions into an integrated form is referred to as a bulky type.

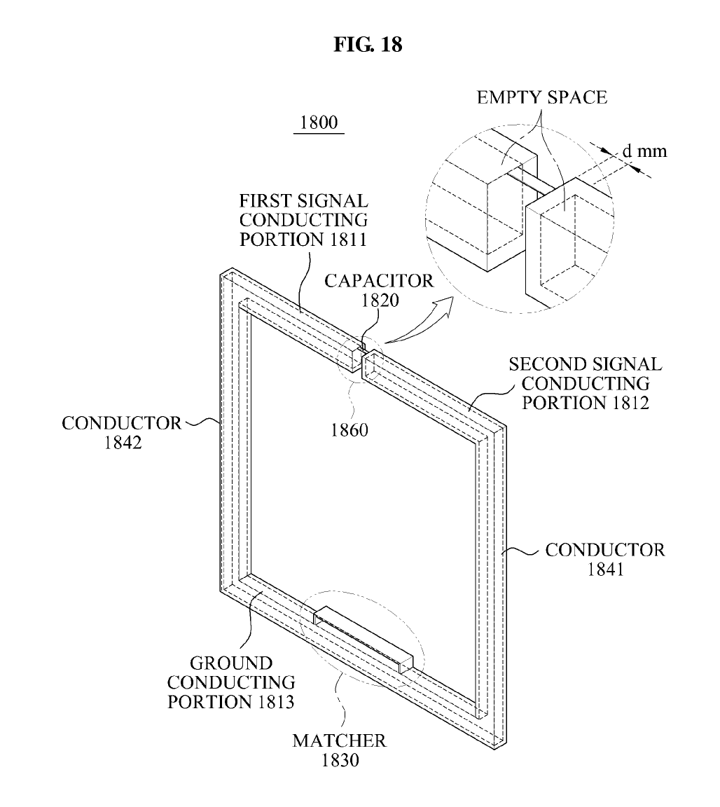

FIG. 18 illustrates an example of a resonator 1800 for a wireless power transmission, configured as a hollow type.

Referring to the example in FIG. 18, each of a first signal conducting portion 1811, a second signal conducting portion 1812, a ground conducting portion 1813, and conductors 1841 and 1842 of the resonator 1800 configured as the hollow type includes an empty space inside.

In a given resonance frequency, an active current may be modeled to flow in only a portion of the first signal conducting portion 1811 instead of all of the first signal conducting portion 1811, the second signal conducting portion 1812 instead of all of the second signal conducting portion 1812, the ground conducting portion 1813 instead of all of the ground conducting portion 1813, and the conductors 1841 and 1842 instead of all of the conductors 1841 and 1842. Specifically, when a depth of each of the first signal conducting portion 1811, the second signal conducting portion 1812, the ground conducting portion 1813, and the conductors 1841 and 1842 is significantly deeper than a corresponding skin depth in the given resonance frequency, it may be ineffective. The significantly deeper depth may increase a weight or manufacturing costs of the resonator 1800.

Accordingly, in the given resonance frequency, the depth of each of the first signal conducting portion 1811, the second signal conducting portion 1812, the ground conducting portion 1813, and the conductors 1841 and 1842 may be appropriately determined based on the corresponding skin depth of each of the first signal conducting portion 1811, the second signal conducting portion 1812, the ground conducting portion 1813, and the conductors 1841 and 1842. When each of the first signal conducting portion 1811, the second signal conducting portion 1812, the ground conducting portion 1813, and the conductors 1841 and 1842 has an appropriate depth deeper than a corresponding skin depth, the resonator 1800 may become light, and manufacturing costs of the resonator 1800 may also decrease.

For example, as shown in the example of FIG. 18, the depth of the second signal conducting portion 1812 is determined as “d” mm and d is determined according to

$$d = \frac{1}{\sqrt{π f μσ}} .$$

Here, f denotes a frequency, μ denotes a magnetic permeability, and σ denotes a conductor constant. When the first signal conducting portion 1811, the second signal conducting portion 1812, the ground conducting portion 1813, and the conductors 1841 and 1842 are made of a copper and have a conductivity of 5.8×10⁷ siemens per meter (S·m⁻¹), the skin depth may be about 0.6 mm with respect to 10 kHz of the resonance frequency and the skin depth may be about 0.006 mm with respect to 100 MHz of the resonance frequency.

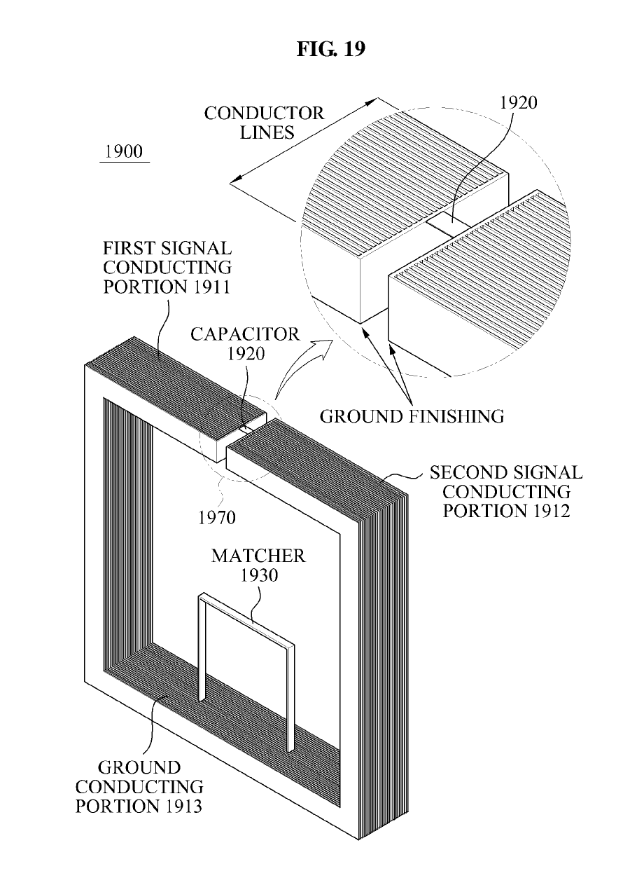

FIG. 19 illustrates an example of a resonator 1900 for a wireless power transmission using a parallel-sheet.

Referring to the example in FIG. 19, the parallel-sheet may be applicable to each of a first signal conducting portion 1911 and a second signal conducting portion 1912 included in the resonator 1900.

Each of the first signal conducting portion 1911 and the second signal conducting portion 1912 may not be a perfect conductor and thus, may have a resistance. Due to the resistance, an ohmic loss may occur. The ohmic loss may decrease a Q-factor and also decrease a coupling effect.

By applying the parallel-sheet to each of the first signal conducting portion 1911 and the second signal conducting portion 1912, it is possible to decrease the ohmic loss, and to increase the Q-factor and the coupling effect. Referring to a portion 1970 indicated by a circle, when the parallel-sheet is applied, each of the first signal conducting portion 1911 and the second signal conducting portion 1912 includes a plurality of conductor lines. The plurality of conductor lines may be disposed in parallel, and be shorted at an end portion of each of the first signal conducting portion 1911 and the second signal conducting portion 1912.

As described above, when the parallel-sheet is applied to each of the first signal conducting portion 1911 and the second signal conducting portion 1912, the plurality of conductor lines may be disposed in parallel. Accordingly, a sum of resistances having the conductor lines may decrease. Consequently, the resistance loss may decrease, and the Q-factor and the coupling effect may increase.

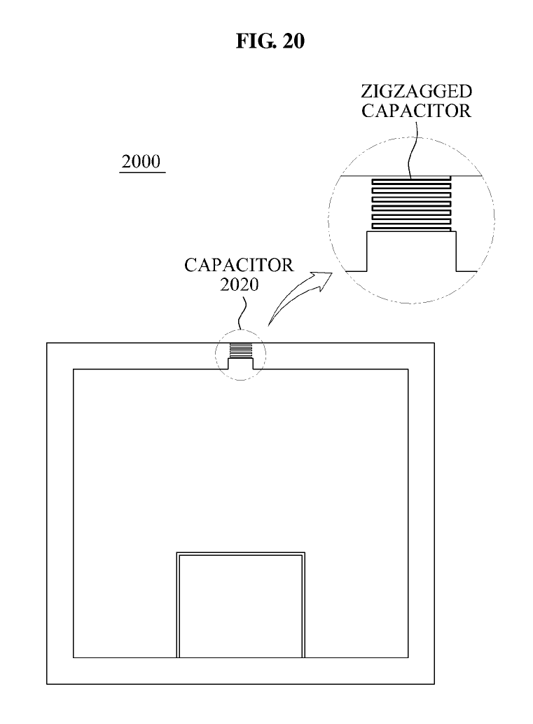

FIG. 20 illustrates an example of a resonator 2000 for a wireless power transmission, including a distributed capacitor.

Referring to the example in FIG. 20, a capacitor 2020 included in the resonator 2000 for the wireless power transmission is a distributed capacitor. A capacitor as a lumped element may have a relatively high equivalent series resistance (ESR). A variety of schemes have been proposed to decrease the ESR contained in the capacitor of the lumped element. According to some examples, by using the capacitor 2020 as a distributed element, it is possible to decrease the ESR. A loss caused by the ESR may decrease a Q-factor and a coupling effect.

As shown in the example of FIG. 20, the capacitor 2020 as the distributed element may have a zigzagged structure. For example, the capacitor 2020 as the distributed element may be configured as a conductive line and a conductor having the zigzagged structure.

As shown in FIG. 20, by employing the capacitor 2020 as the distributed element, it is possible to decrease the loss occurring due to the ESR. In addition, by disposing a plurality of capacitors as lumped elements, it is possible to decrease the loss occurring due to the ESR. Since a resistance of each of the capacitors as the lumped elements decreases through a parallel connection, active resistances of parallel-connected capacitors as the lumped elements may also decrease whereby the loss occurring due to the ESR may decrease. For example, by employing ten capacitors of 1 pF instead of using a single capacitor of 10 pF, it is possible to decrease the loss occurring due to the ESR.

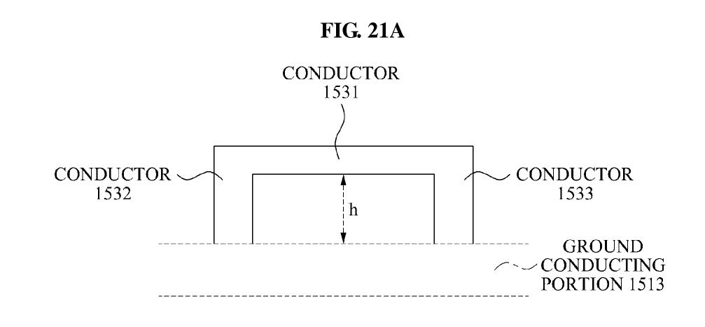

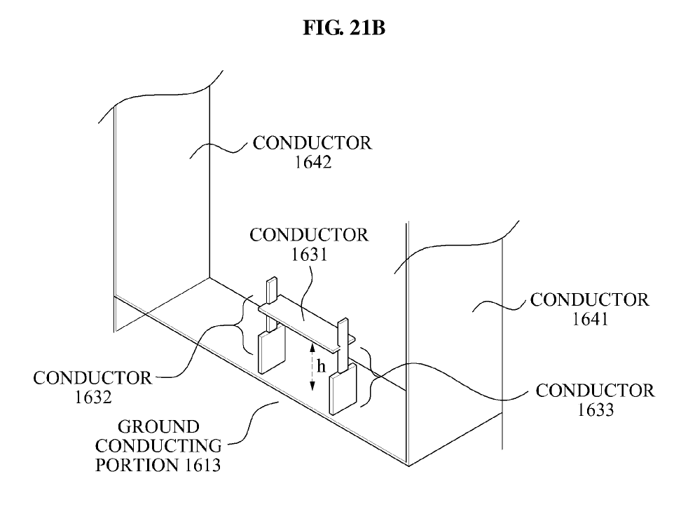

FIG. 21A illustrates an example of the matcher 1530 used in the resonator 1500 provided in the 2D structure of FIG. 15, and FIG. 21B illustrates an example of the matcher 1630 used in the resonator 1600 provided in the 3D structure of FIG. 16.

Specifically, FIG. 21A illustrates a portion of the 2D resonator including the matcher 1530, and FIG. 21B illustrates a portion of the 3D resonator of FIG. 16 including the matcher 1630.

Referring to the example in FIG. 21A, the matcher 1530 includes the conductor 1531, a conductor 1532, and a conductor 1533. The conductors 1532 and 1533 are connected to the ground conducting portion 1513 and the conductor 1531. The impedance of the 2D resonator may be determined based on a distance h between the conductor 1531 and the ground conducting portion 1513. The distance h between the conductor 1531 and the ground conducting portion 1513 may be controlled by the controller. The distance h between the conductor 1531 and the ground conducting portion 1513 may be adjusted using a variety of schemes. For example, the variety of schemes may include a scheme of adjusting the distance h by adaptively activating one of the conductors 1531, 1532, and 1533, a scheme of adjusting the physical location of the conductor 1531 up and down, and the like.

Referring to the example FIG. 21B, the matcher 1630 includes the conductor 1631, a conductor 1632, and a conductor 1633. The conductors 1632 and 1633 are connected to the ground conducting portion 1613 and the conductor 1631. The impedance of the 3D resonator may be determined based on a distance h between the conductor 1631 and the ground conducting portion 1613. The distance h between the conductor 1631 and the ground conducting portion 1613 may be controlled by the controller. Similar to the matcher 1530 included in the 2D structured resonator, in the matcher 1630 included in the 3D structured resonator, the distance h between the conductor 1631 and the ground conducting portion 1613 may be adjusted using a variety of schemes. For example, the variety of schemes may include a scheme of adjusting the distance h by adaptively activating one of the conductors 1631, 1632, and 1633, a scheme of adjusting the physical location of the conductor 1631 up and down, and the like.

Although not illustrated in FIGS. 21A and 21B, the matcher may include an active element. A scheme of adjusting an impedance of a resonator using the active element may be similar as described above. For example, the impedance of the resonator may be adjusted by changing a path of a current flowing through the matcher using the active element.

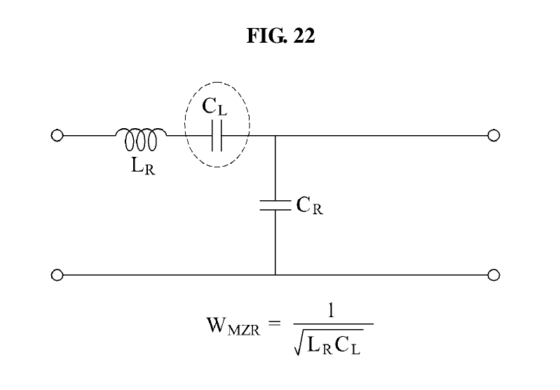

FIG. 22 illustrates an example of an equivalent circuit of the resonator 1500 of FIG. 15.

The resonator 1500 for the wireless power transmission may be modeled to the equivalent circuit of FIG. 22. In the equivalent circuit of FIG. 22, C_{L} denotes a capacitor that is inserted in a form of a lumped element in the middle of the transmission line of FIG. 15.

Here, the resonator 1500 may have a zeroth resonance characteristic. For example, when a propagation constant is “0”, the resonator 1500 may be assumed to have ω_{MZR} as a resonance frequency. In this example, the resonance frequency ω_{MZR} is expressed by Equation 1.

$${ω}_{MZR} = \frac{1}{\sqrt{{L}_{R} {C}_{L}}} \qquad [ Equation 1 ]$$

In Equation 1, MZR denotes a Mu zero resonator.

Referring to Equation 1, the resonance frequency ω_{MZR} or the resonator 1500 is determined by L_{R}/C_{L}. A physical size of the resonator 1500 and the resonance frequency ω_{MZR} may be independent with respect to each other. Since the physical sizes are independent with respect to each other, the physical size of the resonator 1500 may be sufficiently reduced.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A television (TV) system, comprising:
a TV set-top box (STB); and
a TV set; and
a shielding unit;
the TV STB comprising a source resonating unit, the source resonating unit configured to transmit a resonance power to the TV set;
the TV set comprising a target resonating unit, the target resonating unit configured to receive the resonance power from the source resonating unit; and
the shielding unit is configured to focus a magnetic field to the target resonating unit, the magnetic field radiated by the source resonating unit in an omni-direction.

2. The television system of claim 1, wherein the source resonating unit is disposed on an upper end of the TV STB, and
wherein the source resonating unit comprises:
a source resonator; and
a shielding film configured to prevent a current offset between the source resonator and a substrate.

3. The television system of claim 2, wherein the source resonator comprises:
a transmission line unit comprising a plurality of transmission line sheets arranged in parallel; and
a capacitor inserted in a predetermined location of the transmission line unit.

4. The television system of claim 1, wherein the target resonating unit is disposed in a lower end of a supporter of the TV set, or in a rear surface of the TV set, and comprises a target resonator operated at a same resonance frequency as the source resonating unit.

5. The television system of claim 4, wherein the target resonator comprises:
a transmission line unit comprising a plurality of transmission line sheets arranged in parallel; and
a capacitor inserted in a predetermined location of the transmission line unit.

6. The television system of claim 1, wherein the shielding unit comprises:
a housing made of metals; and
a near field focusing unit configured to have a High Impedance Surface (HIS) characteristic, the near field focusing unit disposed in the housing.

7. The television system of claim 6, wherein the near field focusing unit is configured so that a magnetic field of the source resonating unit has an in-phase characteristic.

8. The television system of claim 1, further comprising a plurality of charge target devices;
wherein the source resonating unit detects the plurality of charge target devices, and
wherein each of the plurality of charge target devices receives the resonance power from the source resonating unit by magnetic coupling.

9. The television system of claim 8, wherein each of the plurality of charge target devices receives the resonance power from the source resonating unit, regardless of whether the TV set is powered on or off.

10. The television system of claim 8, wherein the source resonating unit detects the TV set, and the plurality of charge target devices using an identifier of the TV set and identifiers of the plurality of target devices,
wherein the source resonating unit generates a resonance power based on a total sum of a power demanded by the TV set and a power demanded by each of the plurality of charge target devices.

11. The television system of claim 1, wherein the source resonating unit receives a control signal for the TV set from a remote controller, and controls a function of the TV set based on the control signal.

12. A television (TV) set comprising:
a target resonating unit comprising a target resonator;
wherein the target resonating unit configured to receive resonance power from a source resonance unit and the target resonator is operated at a same resonance frequency as the source resonating unit.

13. The television set of claim 12, wherein the target resonator comprises:
a transmission line unit comprising a plurality of transmission line sheets arranged in parallel; and
a capacitor inserted in a predetermined location of the transmission line unit.

14. A television (TV) set-top box (STB) comprising:
a source resonating unit configured to transmit a resonance power to a TV set;
the source resonating unit comprising:
a source resonator; and
a shielding film configured to prevent a current offset between the source resonator and a substrate.

15. The television STB of claim 14, wherein the source resonating unit is disposed on an upper end of the TV STB.

16. The television STB of claim 14, wherein the source resonator comprises:
a transmission line unit comprising a plurality of transmission line sheets arranged in parallel; and
a capacitor inserted in a predetermined location of the transmission line unit.

17. The television STB of claim 14, wherein the source resonating unit detects a plurality of charge target devices and the plurality of charge target devices is configured to receive the resonance power from the source resonating unit by magnetic coupling.

18. The television STB of claim 17, wherein the source resonating unit detects the TV set and the plurality of charge target devices using an identifier of the TV set and identifiers of the plurality of target devices;
wherein the source resonating unit generates a resonance power based on a total sum of a power demanded by the TV set and a power demanded by each of the plurality of charge target devices.

19. The television STB of claim 14, wherein the source resonating unit receives a control signal for the TV set from a remote controller, and controls a function of the TV set based on the control signal.
